(19) United States
(12) Patent Application Publication
(10) Pub. No.: US 2008/0262805 A1
(43) Pub. Date: Oct. 23, 2008

(54) Method for online modeling illumination design

(75) Inventors: Hsin-Lan Lin, Taipei Hsien (TW); Tsung-Ting Sun, Taipei Hsien (TW)

Correspondence Address: BIRCH STEWART KOLASCH & BIRCH, PO BOX 747, FALLS CHURCH, VA, 22040-0747, US

(73) Assignee: EDISON OPTO CORPORATION

(21) Appl. No.: 11/785,512

(22) Filed: Apr. 18, 2007

(51) Int. Cl. G06F 7/60

(52) U.S. Cl. 703/2

(57) ABSTRACT

A method for online modeling illumination design is applied to communicate an illumination modeling system with a user end via an Internet so as to provide for a user to execute an online operation of the modeling illumination design. The method comprises the steps of: pre-writing an illumination modeling program; pre-storing at least one illumination device with at least one device parameter thereof; inputting at least one environment parameter to establish a modeling space; selecting and inputting at least one illumination device from the pre-stored illumination device; inputting an installation position for installing the illumination device; inputting an illumination position; and using the illumination modeling program, according to the environment parameter and the device parameter, to calculate a modeling illumination value of that the illumination device provides to the illumination position when the illumination device is installed to the installation position.

### FIELD OF THE INVENTION

The present invention relates to a method of modeling illumination design, and more particularly to a method for a user to execute the online modeling illumination design via the transmission of an Internet.

### BACKGROUND OF THE INVENTION

For indoor illumination design, a lighting device providing different illumination variations is adopted for the changing environment caused by the alternation of day and night and the variations of weather.

However, in practice, the indoor illumination design is usually executed by a professional designer experienced in indoor illumination design. Even that, some illumination soft has already been developed and sole in the markets, it is just for the usage of the professional designer. Thus, common people hardly have any chance to participate in the indoor illumination design, and rarely have any chance to do “DIY (do it yourself) indoor illumination design”.

Nevertheless, the professional designer has to provide an illumination device list, which is listed with the required illumination devices and their installation positions after finishing the indoor illumination design. After that, said common people have to purchase all the required illumination devices listed in the illumination device list, or they can entrust the professional designer to purchase all the required illumination devices from an illumination device provider. Finally, in accordance with the installation positions listed in the illumination device list, said common people have to install the required illumination devices by themselves or entrust a professional constructor to install the required illumination devices.

### SUMMARY OF THE INVENTION

The problems intend being solved in the present invention and the objects of the present invention are described as follows:

Summarizing above processes of indoor illumination design, said common people only can express their requirements to the professional designer, and hardly have any chance to actually participate in the indoor illumination design. Meanwhile, said common people still have to purchase the requirement illumination devices by themselves or additionally pay for entrusting the professional designer to purchase all the required illumination devices from illumination device providers.

Thus, the primary object of the present invention provides a method for online modeling illumination design, so that said common people can easily finish the indoor illumination design via the Internet.

The secondary object of the present invention provides the method for the online modeling illumination design, so that said common people can easily purchase the indoor illumination design via the Internet.

Another object of the present invention provides the method for the online modeling illumination design, so that said professional designer can provide the services of indoor illumination design to the remote customers via the transmission of the Internet.

Means of the present invention for solving problems: Means of the present invention for solving the problems as mentioned above provide the method for the online modeling illumination design. The method is that communicating an illumination modeling system with a user end via an Internet so as to provide for a user to execute an online operation of the modeling illumination design.

Meanwhile, the method comprises the steps of: pre-writing an illumination modeling program and pre-storing at least one illumination device with at least one device parameter thereof; inputting at least one environment parameter to establish a modeling space; selecting and inputting at least one illumination device from the pre-stored illumination device; inputting an installation position for installing the illumination device by the user; inputting an illumination position within the modeling space by the user; and using the illumination modeling program, according to the environment parameter and the device parameter, to calculate a modeling illumination value of that the illumination device provides to the illumination position when the illumination device is installed to the installation position.

In a preferred embodiment of the present invention, it is able to store the illumination device(s) to a fit list when the modeling illumination complies with a specified requirement. Moreover, it is able to establish a purchase list for the user to execute an online operation of purchasing the illumination device.

Effects of the present invention with respect to prior arts: Making a comparison between the method of the present invention and the conventional operation of the indoor illumination design and the purchase of the illumination devices as mentioned, the present invention not only can execute indoor illumination design according to a specified requirement without asking for any help from the professional designer experienced in indoor illumination designer, but also can put the required illumination device(s) into the fit list and the purchase list to make the illumination devices be easily purchased after finishing the illumination design.

Besides, for a professional designer experienced in indoor illumination design, when he accept an order from a remote customer via the Internet, it is just necessary for him to get the information of the environment parameters, such as a set of inside dimensions, at least one position of window for natural lighting, the longitude and latitude position, etc., of an indoor space, and then he can execute an operation of modeling illumination design. Thus, said professional designer can provide his service of the indoor illumination design to the remote customers, via the transmission of Internet, without leaving his working office.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram, which illustrates a preferred embodiment of the present invention;

FIG. 2 illustrates a modeling space can be established after a user inputting the environment parameters;

FIG. 3 illustrates the user processes an operation of downloading illumination device data and intends to select and input the illumination device;

FIG. 4 illustrates the user processes an operation of inputting a installation position of the illumination device via a cursor;

FIG. 5 illustrates the user processes an operation of installing the illumination device to an installation position of the modeling space via the cursor;

FIG. 6 illustrates the user processes an operation of inputting an illumination position of the modeling space via the cursor so as to get a modeling illumination value;

FIG. 7 illustrates a list window of the preferred embodiment of the present invention; and

FIG. 8 illustrates a simplified working flowchart of the preferred embodiment of the present invention.

### DETAILED DESCRIPTION OF THE PREFERRED EMBODIMENTS

Due to that the method for online modeling illumination design as provided in accordance with the present invention can be widely applied to any illumination modeling system constructed via the Internet, the combined applications are too numerous to be enumerated and described, so that we only disclose two preferred embodiments for representation.

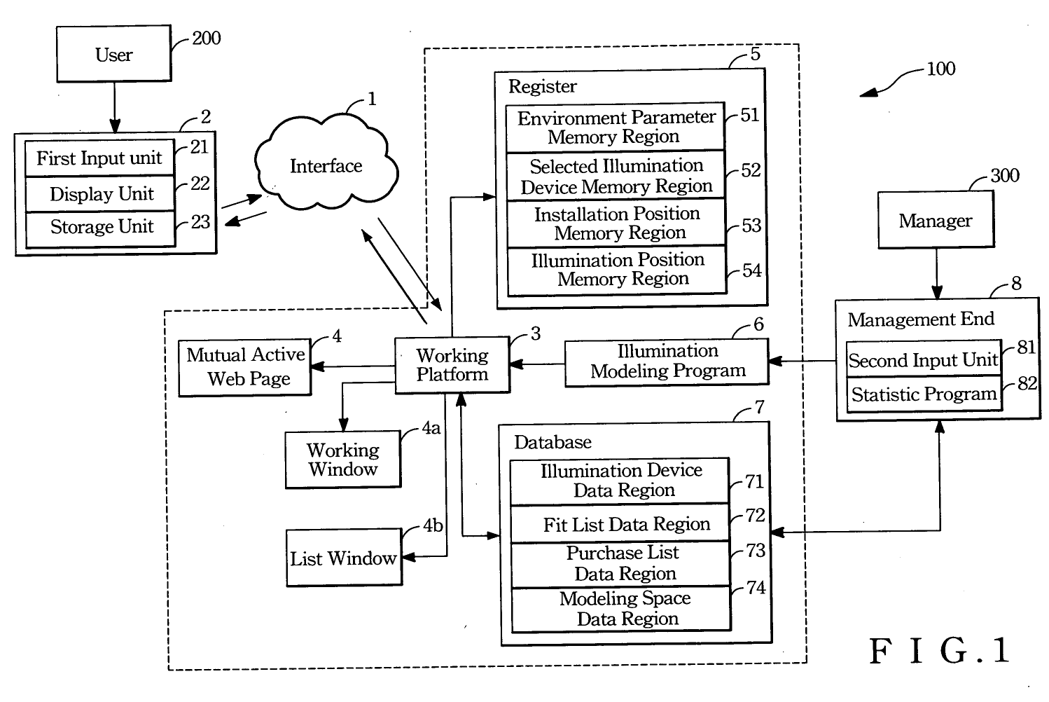

Please refer to FIG. 1, which illustrates a preferred embodiment of the present invention. As shown in FIG. 1, an illumination modeling system 100 communicates with a user end 2 via an Internet 1 so as to provide for a user 200 to execute an online operation of modeling illumination design. The user end 2 comprises a first input unit 21, a display unit 22, and a storage unit 23. The illumination modeling system 100 comprises a working platform 3, a mutual active web page 4, a working window 4a, a list window 4b, a register 5, an illumination modeling program 6, and a database 7.

The working platform 3 communicates with the user end 2 via the Internet 1. The mutual active web page 4 is displayed on the display unit 22 of the user end 2 via the working platform 3 and the Internet 1, and communicated with the working window 4a and the list window 4b via the working platform 3. In practice, the mutual active web page 4, the working window 4a, and the list window 4b can be linked by hyper link, so that each of them can be called and shifted to each other via the working platform 3 by operating any one of them.

The register 5 communicates with the working platform 3, and comprises an environment parameter memory region 51, a selected illumination device memory region 52, an installation position memory region 53, and an illumination position memory region 54. The illumination modeling program 6 communicates with the working platform 3. In practice, the illumination modeling program 6 can be pre-written or pre-implanted into another chip, storage unit (not shown), or the register 5.

The database 7 also communicates with the working platform 3, and comprises an illumination device data region 71, a fit list data region 72, a purchase list data region 73, and a modeling space data region 74. In the preferred embodiment, the illumination modeling program 6 and the database 7 are respectively communicated with a management end 8, so that a manager 300 can execute the maintenance and management of the illumination modeling system 100. The management end 8 comprises a second input unit 81 and a statistic program 82.

When the user 200 intends to execute the modeling illumination design by using the illumination modeling system 100, the user 200 can link the user end 2 to the mutual active web page 4 via the Internet 1 and the working platform 3, and then kick a hyper link selection icon to shift to the working window 4a, so that the working window 4a can be displayed on the display unit 22 of the user end 2.

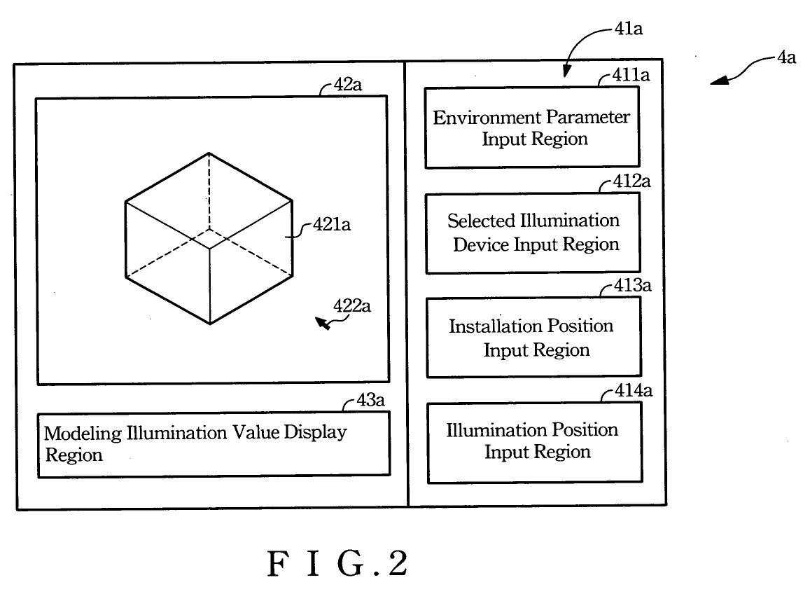

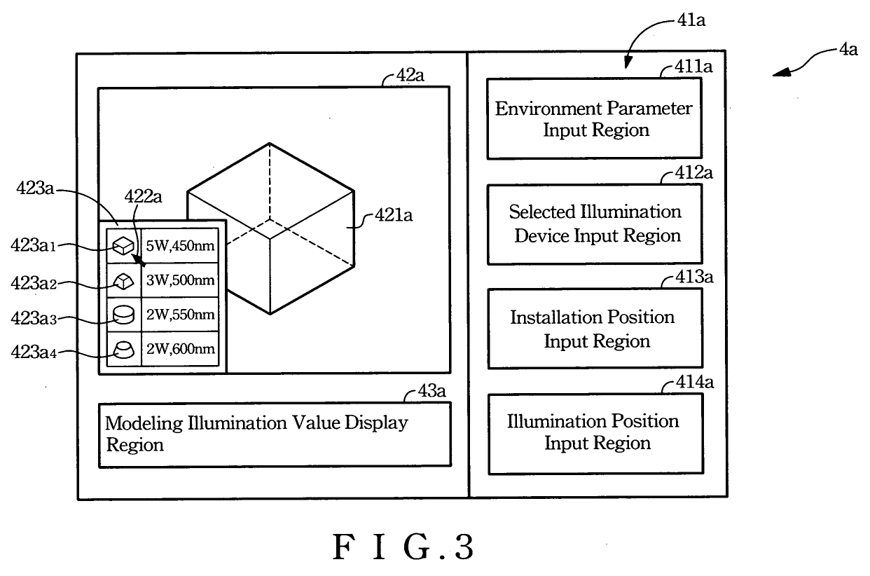

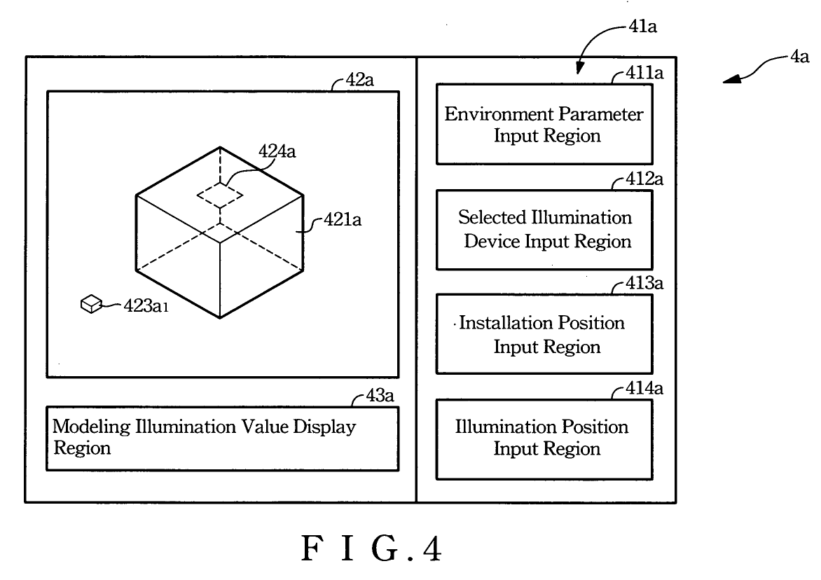

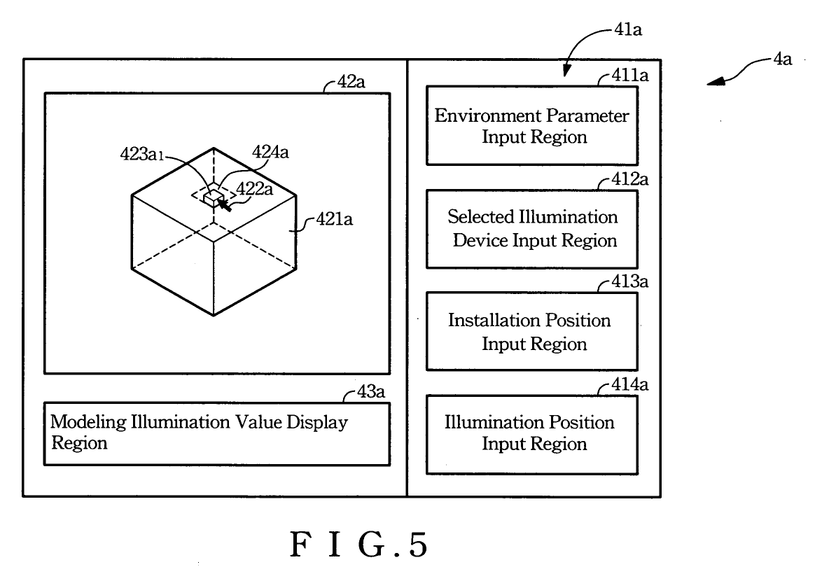

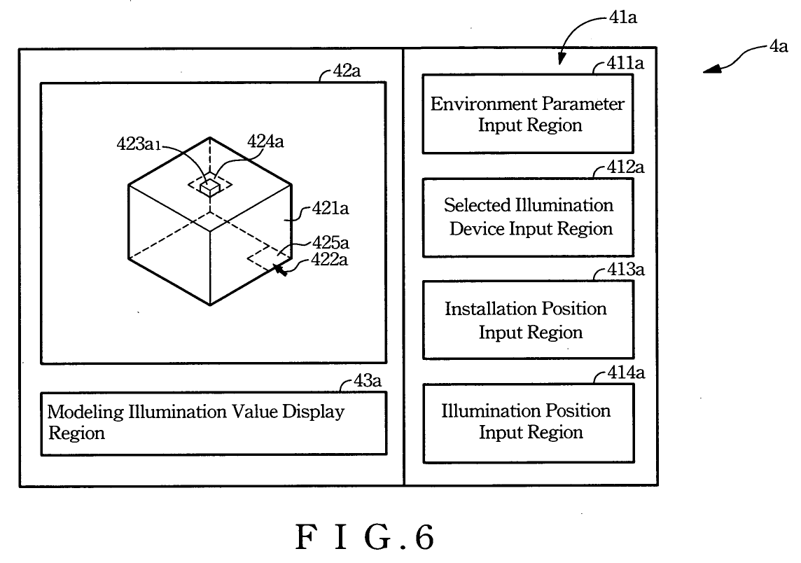

Please refer to FIG. 2 to FIG. 6 illustrating a series of steps that the user executes the modeling illumination design on the working window, wherein FIG. 2 illustrates a modeling space can be established after a user inputting the environment parameters, FIG. 3 illustrates the user processes an operation of downloading illumination device data and intends to select and input the illumination device, FIG. 4 illustrates the user processes an operation of inputting a installation position of the illumination device via a cursor, FIG. 5 illustrates the user processes an operation of installing the illumination device to an installation position of the modeling space via the cursor, and FIG. 6 illustrates the user processes an operation of inputting a illumination position of the modeling space via the cursor so as to get a modeling illumination value. Besides, please simultaneously refer to FIG. 1.

As shown in the drawings, a working window 4a can display an input region 41a, a space display region 42a, and a modeling illumination value display region 43a, wherein the input region 41a includes an environment parameter input region 411a, a selected illumination device input region 412a, an installation position input region 413a, and an illumination position input region 414a.

As shown in FIG. 2, when the user 200 inputs a set of environment parameters, such as the length, the width, and the height of an environment space, the position of window for the natural lighting, the longitude and latitude position, etc., by operating the first input unit 21 of the user end 2, a modeling space 421a and a cursor 422a can be established and displayed on the space display region 42a.

As shown in FIG. 3, the user 200 can input the model number of the illumination device intended to be selected in the selected illumination device input region 412a. Or, the user 200 can download data of the illumination devices from the illumination device data region 71 of the database 7 to open an illumination device data window 423a. In the present embodiment, the illumination device data window 423a includes four kinds of illumination devices 423a l, 423a2, 423a3, and 423a4 and their device parameters, such as the lighting power, the illumination light beam frequency, etc., hereafter, the user 200 can use the cursor 422a to select any of the four illumination devices 423a, 423a2, 423a3, and 423a4. As shown in FIG. 3, the user 200 selects the illumination device 423a1.

As shown in FIG. 4, after above operations, the user 200 can directly input the central coordinate of at least one installation position where the user 200 intends to install the illumination device 423a l in the installation position input region 413a. Or, the user 200 can use the cursor 422a to input an installation position 424a in the modeling space 421a, and then the illumination modeling program 6 can automatically calculate the central coordinate of the installation position 424a. Hereafter, the user 200 can use the cursor 422a to move the illumination device 423a l to the installation, as shown in FIG. 5.

As shown in FIG. 6, following up, the user 200 can directly input the central coordinate of an installation position in the illumination position input region 414a. Or, the user 200 can use the cursor 422a to input an illumination position 425a in the modeling space 421a, and then the illumination modeling program 6 can automatically calculate the central coordinate of the illumination position 425a. Hereafter, according to the environment parameters and the device parameters of the illumination device 423a l, the illumination modeling program 6 can calculate a modeling illumination value, which the illumination device 423a1 provides to the illumination position 425a when the illumination device 423a1 is installed to the installation position 424a, and display the modeling illumination value in the modeling illumination value display region 43a. Nevertheless, the environment parameters, the device parameters, the central coordinate of the installation position, and the central coordinate of the illumination position can be temporally and respectively stored into the environment parameter memory region 51, the selected illumination device memory region 52, the installation position memory region 53, and the illumination position memory region 54 of the register 5.

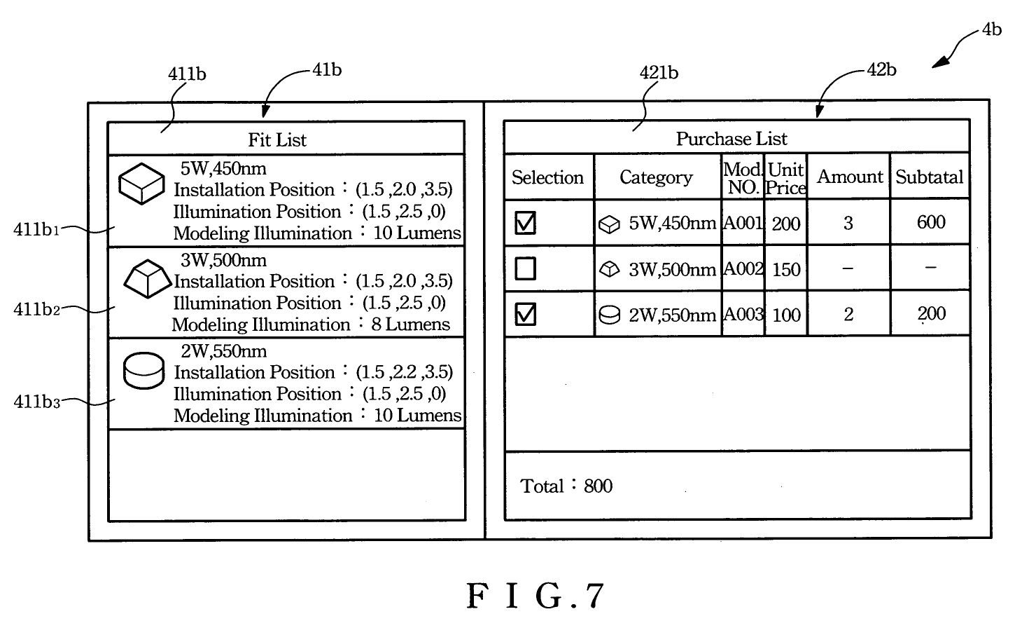

Please refer to FIG. 7, which illustrates a list window of the preferred embodiment of the present invention. As shown in FIG. 7, the list window 4b comprises a fit list display region 41b and a purchase list display region 42b. After finishing above operations, the user 200 can make a judgment of that whether the modeling illumination complies with a specified requirement. The specified requirement can follow an indoor illumination design specification or be made by the user 200. If complying with the specified requirement, the user can shift the working window 4a to the list window 4b, and make the illumination device 423a1, the central coordinate of the installation position 424a, and the central coordinate of the illumination position 425a be stored into a fit list 411b and displayed in the fit list display region 41b, so as to generate a set of fit data 411b1. In FIG. 7, there are three sets of fit data 411b1, 411b2, and 411b3 being displayed in the fit list display region 41b.

Moreover, it is able to establish a purchase list 421b in accordance with the fit list 411b, and be displayed in the purchase list display region 42b. The purchase list 421b presents a set of purchase data, such as the model number, the unit price, the amount, the subtotal price, the total purchase price, etc., for the user 200 making the selection of purchase. In practice, the user 200 can download and store the fit list 411b, the purchase list 421b, and the modeling space 421a into the storage unit 23 of the user end 2 via the Internet 1.

Meanwhile, the fit list 411b, the purchase list 421b, and the modeling space 421a also can be respectively stored into the fit list data region 72, the purchase list data region 73, and the modeling space data region 74 of the database 7. The statistic program 82 of the management end 8 can calculate a first amount of the illumination devices stored in the fit list 411b and a second amount of the illumination devices stored in the purchase list 421b at a preset time, such as 03:00 PM per day. Additionally, the manager 300 can use the second input unit 81 of the management end 8 to revise, delete and add the device parameter of the illumination device stored in the database 7, and revise the illumination modeling program 6.

When more and more said users 200 use the illumination modeling system 100 to execute the modeling illumination design, the manager 300 can exactly catch the current requirement and estimate the potential value of the illumination device market via calculating the first amount of the illumination devices stored in the fit list 411b and the second amount of the illumination devices stored in the purchase list 421b by the statistic program 82. Certainly, said user 200 can be any of the common people, and also can be a professional designer experienced in the indoor illumination design. Thus, said professional designer can provide his service of indoor illumination design to the remote customers, via the transmission of Internet 1, without leaving his working office.

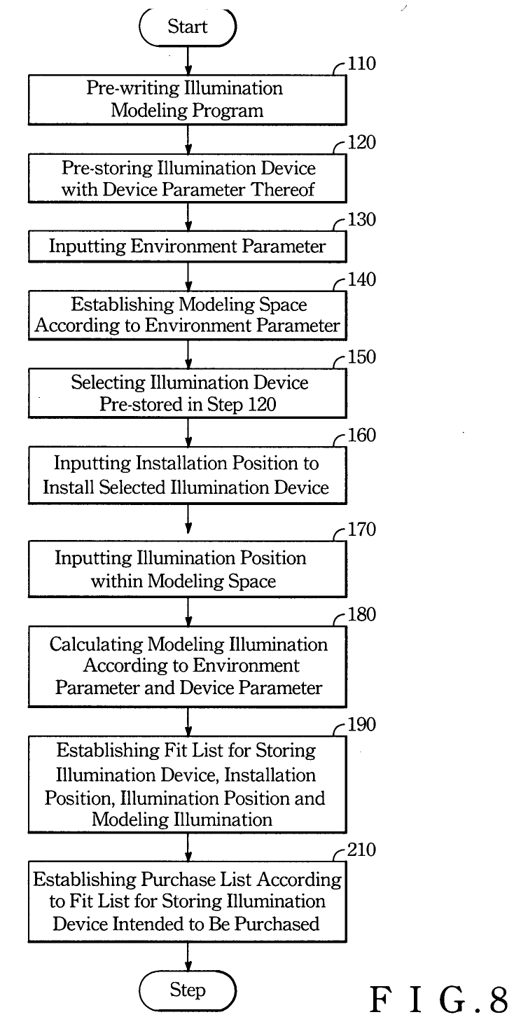

Since the details of the preferred embodiment have been disclosed in above description, following up, we will summarize above description to a simplified working flowchart, which can be easily read by people skilled in related arts. Please refer the FIG. 8, which illustrates a simplified working flowchart of the preferred embodiment of the present invention, and simultaneously refer to FIG. 1 to FIG. 7. The method for the online modeling illumination design of the present invention communicates the illumination modeling system 100 with the user end 2 via the Internet 1 so as to provide for the user 200 to execute the online operation of the modeling illumination design.

The method comprises the steps of: pre-implanting or pre-writing the illumination modeling program 6 into the illumination modeling system 100 (step 110); pre-storing at least one illumination device with at least one device parameter thereof (step 120); inputting at least one environment parameter via the user end 2 by the user 200, and transmitting the environment parameter to the illumination modeling system 100 via the Internet 1 (step 130); establishing a modeling space 421a in the illumination modeling system 100, and displaying the modeling space 421a on the user end 2 (step 140); inputting at least one of the illumination device pre-stored in step 120 via the user end 2 by the user 200 (step 150); and inputting at least one installation position 424a within the modeling space 421a for installing the illumination device input in step 150 (step 160).

After executing above steps, the method comprises the steps of: inputting at least one illumination position 425a within the modeling space 421a via the user end 2 by the user 200 (step 170); using the illumination modeling program 6 to calculate the modeling illumination value, which the illumination device provides to the illumination position 425a when the illumination device is installed to the installation position 424a (step 180).

Moreover, after executing above steps, the method further comprises the steps of: establishing a fit list 411b for storing the illumination device, the central coordinate of the installation position 424a, the central coordinate of the illumination position 425a, and the modeling illumination value when the modeling illumination value complies with a specified requirement (step 190); and establishing a purchase list 421a, according to the fit list 411b, for storing the illumination device that the user 200 intends to purchase (step 210).

In practice, when the manager 300 is an illumination device designer, manufacturer, or provider, for conveniently tracing and catching all data generated when the user 200 executing the online operation of the modeling illumination design, it is capable of automatically catching the email address, information of the user 200, or any data related to the illumination design, and storing them into the database 7 via a login process before or after executing all the steps as mentioned above. Therefore, through the login process, the illumination device designer, manufacturer, or provider can catch the structure and potential of the illumination device market more exactly, so as to accordingly make a proper policy of the illumination device research and development, and the illumination device market development.

Although the present invention has been described with reference to the preferred embodiments thereof, it is apparent to those skilled in the art that a variety of modifications and changes may be made without departing from the scope of the present invention which is intended to be defined by the append claims.

What is claimed is:

1. A method for online modeling illumination design applied to communicate an illumination modeling system with a user end via an Internet so as to provide for a user to execute an online operation of the modeling illumination design, and comprising the steps of:
(a) pre-writing an illumination modeling program and pre-storing at least one illumination device with at least one device parameter thereof;
(b) inputting at least one environment parameter to establish a modeling space;
(c) selecting and inputting at least one said illumination device from the illumination device pre-stored in step (a) by the user;
(d) inputting an installation position for installing the illumination device by the user;
(e) inputting an illumination position within the modeling space by the user; and
(f) using the illumination modeling program, according to the environment parameter and the device parameter, to calculate a modeling illumination value of that the illumination device provides to the illumination position when the illumination device is installed to the installation position.

2. The method for online modeling illumination design as claimed in claim 1, wherein the user end comprises a first input unit for the user inputting the environment parameter, the illumination device, the installation position, and the illumination position.

3. The method for online modeling illumination design as claimed in claim 1, wherein the illumination modeling system comprises:
a working platform capable of communicating with the Internet and the illumination modeling program, and further communicating with the user end via the Internet;
a mutual active web page capable of communicating with the user end via the working platform and the Internet; and
a working window capable of communicating with the working platform and being called when the mutual active web page is operated by the user.

4. The method for online modeling illumination design as claimed in claim 3, wherein the working window is applied for displaying the environment parameter, the modeling space, the illumination device, the installation position, the illumination position, and the modeling illumination value.

5. The method for online modeling illumination design as claimed in claim 4, wherein the user end comprises a display unit for displaying the environment parameter, the modeling space, the illumination device, the installation position, the illumination position, and the modeling illumination value displayed on the working window when the user end communicates with the mutual active web page via the Internet.

6. The method for online modeling illumination design as claimed in claim 1, wherein the illumination modeling system further comprises a register for temporally memorizing the environment parameter, the illumination device, the installation position, and the illumination position inputted by the user.

7. The method for online modeling illumination design as claimed in claim 1, further comprising a step (g), which is establishing a fit list for storing the illumination device, the installation position, the illumination position, and the modeling illumination value when the modeling illumination value complies with a specified requirement.

8. The method for online modeling illumination design as claimed in claim 7, wherein the user end further comprises a storage unit for downloading and storing the fit list.

9. The method for online modeling illumination design as claimed in claim 7, wherein the illumination modeling system further comprises a database for storing the fit list.

10. The method for online modeling illumination design as claimed in claim 9, wherein the database further communicates with a management end installed with a statistic program for calculating a first amount of the illumination device stored in the fit list.

11. The method for online modeling illumination design as claimed in claim 10, wherein the management end comprises a second input unit for a manager revising, deleting and adding the device parameter of the illumination device, and revising the illumination modeling program.

12. The method for online modeling illumination design as claimed in claim 1, further comprising a step (h), which is establishing a purchase list for storing the illumination device that the user intends to purchase.

13. The method for online modeling illumination design as claimed in claim 12, before the step (h), further comprising a step (g1), which is establishing a fit list for storing the illumination device, the installation position, the illumination position, and the modeling illumination value when the modeling illumination value meets a specified requirement.

14. The method for online modeling illumination design as claimed in claim 13, wherein the purchase list is established in accordance with the fit list.

15. The method for online modeling illumination design as claimed in claim 12, wherein the user end further comprises a storage unit for downloading and storing the purchase list.

16. The method for online modeling illumination design as claimed in claim 12, wherein the illumination modeling system further comprises a database for storing the purchase list.

17. The method for online modeling illumination design as claimed in claim 16, wherein the database further communicates with a management end installed with a statistic program for calculating a second amount of the illumination device stored in the purchase list.

18. The method for online modeling illumination design as claimed in claim 17, wherein the management end comprises a second input unit for a manager revising, deleting, and adding the device parameter of the illumination device, and revising the illumination modeling program.

19. The method for online modeling illumination design as claimed in claim 1, wherein the environment parameter is a set of environment space dimensions.

20. The method for online modeling illumination design as claimed in claim 1, wherein the device parameter is an illumination power of the illumination device.

21. The method for online modeling illumination design as claimed in claim 1, wherein the device parameter is an illumination light beam frequency of the illumination device.
